(19) United States
(12) Patent Application Publication
(10) Pub. No.: US 2026/0191248 A1
(43) Pub. Date: Jul. 9, 2026

(54) HIGH PROTEIN, LOW NET CARBOHYDRATE SOFT SNACK AND METHODS OFMAKING

(71) Applicant: GENERAL MILLS, INC., Minneapolis, MN (US)

(72) Inventors: Ying FAN, Minneapolis, MN (US); Michelle MANDERFELD, Plymouth, MN (US); Sarah ROSENE, Maple Grove, MN (US)

(73) Assignee: GENERAL MILLS, INC., Minneapolis, MN (US)

(21) Appl. No.: 19/117,506

(22) PCT Filed: Oct. 7, 2022
(86) PCT No.: PCT/US2022/046074

§ 371 Date: Apr. 1, 2025

(51) Int. Cl. A23L 33/18; A23L 29/10; A23L 33/125; A23L 33/185; A23L 33/19

(52) U.S. Cl. CPC A23L 33/18; A23L 29/10; A23L 33/125; A23L 33/185; A23L 33/19

(57) ABSTRACT

A soft, shelf stable food product including a high protein matrix and particulates that retains a soft, moist eating experience over an extended shelf life is described. The high protein matrix includes hydrolyzed collagen and a soluble fiber syrup that enable high levels of vegetable protein and an overall high amount of protein, while avoiding poor eating qualities typically associated with vegetable protein. Methods of making a food product are also disclosed.

### BACKGROUND

Consumers are increasingly looking for foods that meet their nutritional needs without requiring preparation. Shelf stable, soft snack items are a category of ready-to-eat foods that can be challenging to make fit both nutritional needs and a desired eating experience. High protein, low net carbohydrate ready to eat foods suffer from dry texture, poor flavor, and hardening over shelf life. This is particularly true of soft snacks, where poor texture and hardening are more pronounced than in products such as crunchy cookies, crackers, or candy bar-like foods. Thus, there is a need for good-tasting ready-to-eat products that meet desired nutritional needs and retain a desirable eating experience over shelf life.

### SUMMARY

The present disclosure relates to a high protein soft snack that retains a soft, moist eating experience over shelf life.

A shelf stable food product is provided herein. The food product can have a product protein content over 30% by weight and a net carbohydrate content of less than 7% by weight. The shelf stable food product includes a soft, cold-formed composition in an amount of at least 50% by weight of the food product, the composition having a water activity of less than 0.68 and a stable texture over at least 4 months. The cold-formed composition includes a matrix in an amount about 80% to about 90% by weight of the composition, with the matrix comprising a matrix protein content of at least 30% by weight of the matrix, the matrix protein content contributing protein in an amount of about 60% to about 75% by dry weight of the product protein content; whey protein isolate contributing protein in an amount of about 40% to about 50% by dry weight of the matrix protein content; plant-based protein isolate contributing protein in an amount of about 40% to about 50% by dry weight of the matrix protein content; casein-containing protein contributing protein in an amount of about 6% to about 12% by dry weight of the matrix protein content; hydrolyzed collagen contributing protein in an amount of about 1.5% to about 4% by dry weight of the matrix protein content; soluble fiber syrup in an amount of about 28% to about 38% by weight of the matrix; glycerol in an amount of about 5% to about 12% by weight of the matrix; and non-glycerol sugar alcohol in an amount of about 4% to about 10% by weight of the matrix. The cold-formed composition also includes particulates in an amount of about 10% to about 20% by weight of the composition, the particulates distributed throughout the matrix, and contributing protein in an amount of about 15% to about 32% by dry weight of the product protein content. The shelf stable food can include a fat-based coating at least partially coating the cold-formed composition, the fat-based coating comprising about 15% to about 22% by weight of the food product and contributing protein in an amount of about 5% to about 22% by dry weight of the product protein content.

In some embodiments, the food product can contain less than 20% by weight fat.

In some embodiments, the matrix can have less than 3% by weight hydrolyzed or partially hydrolyzed dairy protein and less than 3% by weight milk protein isolate and milk protein concentrate.

In some embodiments, the plant-based protein isolate can include soy protein isolate, pea protein isolate, or wheat protein isolate. In some embodiments, the plant-based protein isolate can include soy protein isolate. In some embodiments, a soy protein isolate can comprise at least a first soy protein isolate and a second soy protein isolate.

In some embodiments, the matrix can include lecithin in an amount of 0% to about 3% by weight of the matrix.

In some embodiments, the particulates can include soy crisps, soy nuggets, or soy puffs having a protein content of at least 80% by dry weight of the particulates.

In some embodiments, the matrix can include cocoa powder, vegetable powder, nut flour, legume flour, and/or fruit powder in an amount of up to 8% by weight of the matrix.

In some embodiments, a cold-formed composition can comprise inclusions.

In some embodiments, a matrix can include a matrix protein content of 30% to about 45% by weight of the matrix; whey protein isolate contributing protein in an amount of about 44% to about 50% by dry weight of the matrix protein content; soy protein isolate contributing protein in an amount of about 40% to about 46% by dry weight of the matrix protein content; casein-containing protein contributing protein in an amount of about 7% to about 11% by dry weight of the matrix protein content; hydrolyzed collagen contributing protein in an amount of about 1.8% to about 3% by dry weight of the matrix protein content; liquid inulin or fructooligosaccharide syrup in an amount of about 30% to about 36% by weight of the matrix; glycerol in an amount of about 6% to about 10% by weight of the matrix; erythritol in an amount of 5% to about 9% by weight of the matrix; and lecithin in an amount of about 1% to about 3% by weight of the matrix.

A method of making a shelf stable food product is also provided. The food product can have a product protein content over 30% by weight, and a net carbohydrate content of less than 7% by weight. The method can include providing a dry mix; providing a slurry; combining the dry mix and the slurry and mixing until combined to form a matrix including the matrix protein content in an amount of least 30% by weight of the matrix; combining the matrix with particulates to form a composition that includes the matrix in an amount about 80% to about 90% by weight of the composition and the particulates in an amount of about 10% to about 20% by weight of the composition, the particulates distributed throughout the matrix and contributing protein in an amount of about 15% to about 32% by dry weight of the product protein content; cold-forming the composition to produce core pieces; and at least partially coating the core pieces with a fat-based coating to make the food product, the fat-based coating comprising about 15% to about 30% by weight of the food product and contributing protein in an amount of about 5% to about 25% by dry weight of the product protein content. The dry mix can have a matrix protein content contributing protein in an amount of about 60% to about 75% by dry weight of the product protein content. The dry mix can include whey protein isolate contributing protein in an amount of about 40% to about 50% by dry weight of the matrix protein content; plant-based protein isolate contributing protein in an amount of about 40% to about 50% by dry weight of the matrix protein content; casein-containing protein contributing protein in an amount of about 6% to about 12% by dry weight of the matrix protein content; and hydrolyzed collagen contributing protein in an amount of about 1.5% to about 4% by dry weight of the matrix protein content. The slurry can include soluble fiber syrup in an amount of about 50% to about 65% by weight of the slurry; glycerol in an amount of about 10% to about 20% by weight of the slurry; and non-glycerol sugar alcohol in an amount of about 7% to about 16% by weight of the slurry.

In some embodiments of a method provided herein, the non-glycerol sugar alcohol can comprise erythritol in an amount of about 8% to about 15% by weight of the slurry.

In some embodiments, a method can include a step of heating the slurry to at least partially dissolve the erythritol. In some embodiments, a method can comprise a step of cooling the slurry prior to combining with the dry mix.

In some embodiments of a method provided herein, the plant-based protein isolate can include soy protein isolate, pea protein isolate, or wheat protein isolate. In some embodiments, the plant-based protein isolate can comprise soy protein isolate.

### DETAILED DESCRIPTION

Consumers often look for convenient foods that fit a desired nutritional profile. A combination of high protein and low net carbohydrate content fits one such nutritional profile. However, including high amounts of protein in many convenient, shelf stable foods can result in textures or flavors that are off-putting, and can lead to hardening and/or changes in texture over shelf life. Further, high protein content can lead to difficulty achieving a texture that remains soft and/or perceived as moist over shelf life, rather being hard, crumbly, firm, or crispy, or becoming hard, crumbly, firm, or crispy over shelf life. Formulating a shelf-stable, high protein food that is also low in net carbohydrate content is even more difficult, as sugars can be used to overcome or mask some of the off-flavors and poor texture often present in high protein foods.

The inventors of the present application were tasked with producing a soft, shelf stable snack food that has a high protein content (e.g., over 30%, or from about 35% to about 40% protein by weight). The inventors were further tasked with ensuring that the snack food had a low net carbohydrate content (e.g., less than 7%, less than 5%, or 3% to about 4% by weight), without relying on a high fat content to achieve a good texture and taste over the shelf life of the product. Preferably, a food product provided herein includes less than 15% (e.g., less than 12%, or less than 10%) by weight fat. As used herein, percent weight content is on an “as is” basis unless otherwise indicated. Generally, when protein content is provided on a dry weight basis, it is as a percentage by dry weight of a matrix protein content or as a percentage by dry weight of a product protein content.

The inventors discovered that a food product could be made that retains a stable texture over at least 4 months (e.g., at least 6 months, or at least 8 months) of shelf life by using an approach that includes a soft, cold-formed composition with a matrix that contributes a first portion of the product protein content, and particulates distributed throughout the matrix that contribute a second portion of the product protein content, along with a fat-based coating at least partially coating the cold-formed composition that contributes a third portion of the product protein content. In particular, a matrix that includes a particular range of hydrolyzed collagen, as well as a particular range of a soluble fiber syrup, such as liquid inulin and/or fructooligosaccharides, can enable the inclusion of high levels of protein and low net carbohydrate levels, without relying on high fat content, while benefiting from a less bitter taste, reduced off flavors, reduced hardening over shelf life, and/or reduced perception of dryness due to textural changes over shelf life as compared to similar commercially available products.

### Matrix

A food product provided herein includes a soft, cold-formed composition comprising a matrix and particulates. The soft, cold-formed composition forms a core of the product and typically makes up at least 50% (e.g., about 60% to about 95%, or about 70% to about 90%) by weight of the product. The composition is cold-formed, meaning that the ingredients are combined and formed without requiring a further cooking step, such as baking, microwaving, or frying.

The matrix of a snack food provided herein is included in an amount of about 80% to about 90% (e.g., about 82% to about 88%) by weight of the soft, cold-formed composition, with a matrix protein content of at least 30% (e.g., 30% to about 45%, or about 32% to about 42%) by weight of the matrix. Although the matrix contributes a high amount of protein (e.g., about 60% to about 75%, or about 62% to about 72% by dry weight of the product protein content) to the food product, it surprisingly maintains a pleasant taste and soft, moist eating experience over shelf life.

In particular, the matrix contains a range of hydrolyzed collagen (contributing protein in an amount of about 1.5% to about 4%, about 1.8% to about 3%, or about 2% to about 2.5% by dry weight of the matrix protein content) and a range of soluble fiber syrup (e.g., about 25% to about 35%, or about 30% to about 35% by weight of the matrix) that combine synergistically to enable the inclusion of relatively high levels of a plant-based protein (e.g., contributing protein in an amount of about 40% to about 50%, or about 40% to about 46% by dry weight of the matrix protein content) in the form of a protein isolate, while reducing or eliminating the negative attributes (e.g., bitter flavor, poor texture, and hardening over shelf life) often associated with high protein content. This is beneficial, at least in part, because plant-based protein can provide high protein content, while often being cost-effective compared to dairy proteins. Suitable plant-based proteins include, for example soy protein, protein from other legumes (e.g., pea protein, bean protein, and the like), wheat protein, and the like. Particularly suitable is soy protein, which is a high-quality protein, while also being cost effective relative to many other high quality protein food ingredients.

As used herein, a protein isolate is a protein ingredient that contains at least 80% (e.g., at least 85%, or at least 90%) by dry weight protein.

In addition, the combination of hydrolyzed collagen and soluble fiber syrup described above, enables a formulation in which the inclusion of hydrolyzed or partially hydrolyzed dairy protein (e.g., hydrolyzed or partially hydrolyzed milk protein, hydrolyzed or partially hydrolyzed whey protein, and the like) can be reduced (i.e., contributing protein in an amount of less than 3%, less than 2%, or less than 1% by dry weight of the matrix protein content) or eliminated. Although hydrolyzed or partially hydrolyzed dairy proteins can counteract some of the negative attributes of protein ingredients, such as hardening, firming, and other texture changes (e.g., perception of dryness, crumbliness, and the like) over shelf life, it was also found to contribute off flavors and bitterness, and compound with plant-based protein, such as soy protein, in enhancing bitter taste in a high protein product. As a result of the inclusion of hydrolyzed collagen and soluble fiber syrup, the amount of plant-based protein could be increased over previously known formulations by at least 50% (e.g., at least 75%, or at least 100%), while still having less bitter flavor in the presence of less or no hydrolyzed or partially hydrolyzed dairy protein.

In some cases, a plant-based protein isolate can be included as either a single protein isolate source, or as a combination of at least two protein isolate sources (e.g., from different manufacturers, or different types from the same manufacturer). Combinations of plant-based protein isolates can be beneficial, as different protein isolate sources, even of the same protein (e.g., soy protein), can have different taste and off flavor profiles, and by blending different plant-based protein isolate sources, negative taste attributes from any one plant-based protein isolate source can be minimized.

It was discovered that commercially available hydrolyzed collagens behave similarly in this system. It was found that an amount of hydrolyzed collagen that contributes protein an amount of less than 1% by dry weight of the matrix protein content resulted in a reduced benefit to avoiding hardening and drying over shelf life. In contrast, amounts of hydrolyzed collagen contributing protein in an amount of over 4% by dry weight of the matrix protein content resulted results in stickiness of the matrix that makes it difficult for handling and/or forming during manufacture of a food product described herein.

As used herein, the term “hydrolyzed collagen” refers to native collagen (an insoluble, triple helical protein) that has been hydrolyzed, typically by enzymes, to form single-stranded peptides that are soluble in hot or cold water and do not form a gel. Hydrolyzed collagen is also sometimes referred to as “collagen peptides.” As used herein, hydrolyzed collagen does not refer to gelatin, which is partially hydrolyzed collagen, typically by heat and/or chemical treatment, that is soluble in hot water and can form a gel.

A soluble fiber syrup suitable for use in a product provided herein includes, for example, fructooligosaccharides, liquid inulin, resistant maltodextrin (e.g., soluble corn fiber), resistant dextrin, polydextrose, galactooligosaccharides, and the like. Preferably, a soluble fiber syrup comprises liquid inulin.

In addition to collagen peptides, soluble fiber syrup, and plant-based protein isolate, the matrix of a cold-formed composition also includes whey protein isolate, casein-containing protein, glycerol, and a non-glycerol sugar alcohol, such as erythritol or maltitol.

Whey protein isolate (WPI) is included in a matrix in an amount sufficient to contribute protein in an amount of about 40% to about 50% (e.g., about 44% to about 50%) by dry weight of the matrix protein content. Whey protein isolate contributes to a cohesive texture and a perception of moistness during consumption. Lower amounts of WPI can result in a product that is perceived to be drier, while higher amounts of WPI can result in a texture that is stickier. In some embodiments, WPI contains at least 90% (e.g., at least 92%, or at least 95%) by dry weight whey protein.

A casein-containing protein (e.g., calcium caseinate (CaCas), sodium caseinate (NaCas), micellar casein, and the like, and any combination thereof) is included in a matrix in an amount sufficient to contribute about 6% to about 12% (e.g., about 7% to about 11%) casein-containing protein by dry weight of the matrix protein content. If used, CaCas can contribute to a tender texture. In addition, CaCas can lighten the color of a food product with increasing amounts. Lower amounts of casein-containing protein can result in a texture that is stickier, while higher amounts can result in a texture that is perceived to be drier, tender, and/or powdery. As used herein, an ingredient used to provide casein-containing protein should contain at least 85% (e.g., at least 90%, at least 92%, or at least 94%) by dry weight casein-containing protein.

Glycerol (also known as glycerin) is included in a matrix in an amount of about 5% to about 12% (e.g., about 6% to about 10%) by weight of the matrix. Glycerol can manage water activity of a shelf stable snack food. In addition, glycerol can contribute to texture. Higher amounts of glycerol can result in an off taste, astringency, and/or structural problems in the finished product.

A matrix includes a non-glycerol sugar alcohol in an amount of about 4% to about 10% (e.g., about 5% to about 9%) by weight of the matrix. A non-glycerol sugar alcohol can provide sweetness to a product described herein without contributing to net carbohydrate content. Preferably, the non-glycerol sugar alcohol comprises erythritol. Although other non-glycerol sugar alcohols, such as maltitol, can be used in a matrix, erythritol can contribute to a preferred flavor over maltitol and a texture that is softer than when maltitol is used. In addition, erythritol has a lower glycemic index than maltitol, so erythritol is often preferred by consumers who are looking to moderate their insulin response to food.

In some embodiments, a matrix can include lecithin. Lecithin can reduce stickiness and/or improve handling of the matrix and soft-formed composition during manufacture. If included, lecithin can be included in an amount of up to about 3% (e.g., 0% to about 3%, or about 1.5% to about 2.2%) by weight of the matrix.

Water can be included in a matrix in an amount of about 4.5% to about 6% by weight of the matrix. Water can be used to solubilize and/or suspend ingredients in a slurry used to make the matrix, as described below. Water in amounts too high can result in a water activity in a cold-formed composition that is too high (e.g., above 0.68) to ensure the desired shelf life. Water activity in a cold-formed composition is preferred to be below 0.68 (e.g., below 0.66, or from about 0.6 to about 0.65). Additional water can be contributed by other ingredients to result in a moisture content that exceeds 6% by weight.

Preferably, the matrix contains less than 3% (e.g., less than 2%, less than 1%) or no milk protein isolate (e.g., hydrolyzed, partially hydrolyzed, or unhydrolyzed milk protein isolate). As discussed above, although milk protein isolate can offset negative sensory texture perception (e.g., crumbliness, overly tender, and the like) and/or hardening over shelf life, it was surprisingly discovered that it contributes to off-flavors and bitter taste, and compounds off-flavors and bitterness from plant-based protein to enhance negative taste attributes in a finished product.

Other ingredients than those described above can be included in a matrix, as appropriate. Typically, all other ingredients combined are included in an amount of less than 7% (e.g., less than 6%, or from about 0.5% to about 5%) by weight of the matrix. Other ingredients can include flavorants (e.g., cocoa powder, salt, fruit and/or vegetable powders, legume flours (e.g., peanut flour), nut flours, spices or seasonings, flavor extracts, flavor oils, high intensity sweeteners, and the like), acidulants, colorants (e.g., fruit and/or vegetable powders or extracts, natural and/or artificial colors, and the like), sugars (e.g., sucrose, fructose, and the like), and the like.

### Particulates And Inclusions

A food product provided herein has particulates that are distributed throughout the matrix in the cold-formed composition. Particulates are included in an amount of about 10% to about 20% (e.g., about 12% to about 18%) by weight of the cold-formed composition. Particulates contribute protein in an amount of about 15% to about 32% (e.g., about 18% to about 30%, or about 20% to about 30%) by dry weight of the product protein content.

In some embodiments, particulates can be selected based on moisture absorption properties of the particulates. For example, particulates with low absorption properties can be selected to reduce moisture migration over shelf life. In another example, particulates with moderate absorption properties can be selected to increase firmness in the cold-formed composition provided herein.

Suitable particulates typically have a protein content of at least 80% (e.g., at least 85%, at least 88%, or at least 90%) by dry weight. Examples include protein crisps, protein flakes, protein bites, protein bits, or protein nuggets made from any suitable protein, such as dairy-based protein, plant-based protein, or blend of proteins. Particularly suitable are protein crisps, protein bits, or protein nuggets made from plant-based protein, such as vegetable protein, grain protein, or legume protein (e.g., soy protein, pea protein, and the like).

A cold-formed composition can optionally contain inclusions distinct from the particulates described above. For example, fat-based chips (e.g., compound, chocolate, or the like), dried fruit, grain-based inclusions (e.g., puffed grain, cut grain, rolled oats, or the like), peanuts, nuts, and the like can be included to provide a preferred flavor and/or texture. In some embodiments, inclusions are formulated to limit fat content and/or net carbohydrate content. For example, an inclusion can comprise a sugar alcohol-sweetened chocolate or compound chip. As with the particulates described above, an inclusion can be selected based on moisture absorption properties to reduce moisture migration over shelf life and/or to adjust the firmness of the cold-formed composition.

### Fat-based Coating and Other Surface Ingredients

A fat-based coating is used to at least partially coat the cold-formed composition comprising the matrix, particulates, and the optional inclusions described above to form a food product provided herein. A fat-based coating can be included in a food product in an amount of about 15% to about 30% (e.g., about 18% to about 25%) by weight of the food product. The amount of fat-based coating can be adjusted to maintain a desired fat content of the food product.

The fat-based coating can contribute protein in an amount of about 5% to about 25% (e.g., about 8% to about 20%) by dry weight of the product protein content. Protein in a fat-based coating can be any suitable protein, such as soy protein, whey protein, milk protein, and the like. A fat-based coating can preferably contain about 15% to about 30% by weight protein to ensure that it contributes sufficient protein without requiring an amount of coating that contributes an undesired amount of fat.

A fat-based coating can be sweetened using any appropriate sweetener. However, it is preferred that a fat-based coating be sweetened using a sugar alcohol, such as erythritol or maltitol, and/or a high intensity sweetener, such as stevia extract, to limit contribution to net carbohydrates.

A food product can optionally include other surface ingredients, such as confectionary pieces, nuts, candies, dried fruits, fat-based decorations, and the like. In some embodiments, such surface ingredients can be selected to contribute to a desired appearance, texture, and/or flavor. In some embodiments, other surface ingredients can be selected and/or formulated to limit fat and/or net carbohydrate content contributed by the ingredients.

### Methods

A matrix as described herein is formed by combining a dry mix with a slurry. A dry mix used in forming the matrix includes the protein ingredients (i.e., plant-based protein isolate, casein-containing protein, hydrolyzed collagen, whey protein isolate, and optional protein, such as milk protein isolate or milk protein concentrate and/or hydrolyzed or partially hydrolyzed dairy protein) and, optionally, cocoa powder, fruit powder, vegetable powder, and/or peanut and/or nut flour. A dry mix will typically contain about 40% to about 50% by weight whey protein isolate, about 40% to about 50% by weight plant-based protein isolate, about 5% to about 10% casein-containing protein, and about 1% to about 4% hydrolyzed collagen.

The slurry includes the remaining ingredients of the matrix. As such, the slurry comprises about 50% to about 65% by weight soluble fiber syrup, about 10% to about 20% by weight glycerol, and about 7% to about 16% by weight non-glycerol sugar alcohol. Other ingredients, such as water and optional ingredients, such as lecithin, flavorants, colorants, acidulants, and sugars are typically included in the slurry.

The slurry can optionally be heated to a temperature of about 110° F. to about 130° F. (e.g., about 115° F. to about 125° F.) to at least partially dissolve erythritol, if included as the non-glycerol sugar alcohol, or to suspend and/or dissolve any other included ingredient. In some embodiments, a slurry can be cooled to a temperature 95° F. or less (e.g., room temperature to about 90° F.) after heating and before combining with the dry mix. In some cases, a slurry temperature that is greater than 95° F. can contribute to a matrix that is more difficult to handle due to stickiness and/or hardness. Dry ice can be optionally used to assist in cooling of the slurry to a target temperature before combining with the dry mix.

A matrix can be made by combining the dry mix and the slurry using any appropriate method. Generally, it is preferred that combining the dry mix and be mixed until just incorporated. The matrix need not be homogeneous before adding particulates, as overmixing can result in hardening and/or increased stickiness of the matrix.

The matrix is then combined with the particulates, and optionally inclusions, to form a composition that includes the matrix in an amount of about 80% to about 90% by weight and the particulates in an amount of about 10% to about 20% by weight. The composition is mixed to distribute the particulates throughout the matrix.

The composition is cold-formed to produce core pieces. A cold-formed composition can be formed using any suitable method. For example, the composition can be slabbed onto a surface and cut into pieces, extruded onto a surface as a rope and then cut, extruded as individual pieces, or molded to form pieces. The formed composition is not baked or otherwise cooked following formation.

In some embodiments, the cold-formed composition can be layered with another composition, such as a similar cold-formed composition with a different flavor, a fat-based composition (e.g., chocolate, compound coating, and the like), a confection (e.g., caramel, nougat, or the like), a soft-baked layer (e.g., brownie, cake, cookie, or the like), particulates (e.g., cookie particulates, nuts, dried fruit, or the like), or the like.

The formed composition, and any optional layers, is then at least partially coated with a fat-based composition to produce a shelf-stable food product. Any suitable method can be used to apply a fat-based coating. Optional steps can include applying other surface ingredients, as described above.

A food product provided herein can be packaged in any suitable packaging, including single serving and multi-serving packages. In some embodiments, packaging that resists moisture transfer and/or oxygen transfer into or out of the packaging can be used.

The implementations described above and other implementations are within the scope of the following claims. One skilled in the art will appreciate that the present disclosure can be practiced with embodiments other than those disclosed.

The following examples are presented for purposes of illustration and not limitation.

1. A shelf stable food product, the food product having a product protein content over 30% by weight and a net carbohydrate content of less than 7% by weight, the shelf stable food product comprising:
a. a soft, cold-formed composition in an amount of at least 50% by weight of the food product, the composition having a water activity of less than 0.68 and a stable texture over at least 4 months and including:
1) a matrix in an amount about 80% to about 90% by weight of the composition, the matrix comprising:
a) a matrix protein content of at least 30% by weight of the matrix, the matrix protein content contributing protein in an amount of about 60% to about 75% by dry weight of the product protein content;
b) whey protein isolate contributing protein in an amount of about 40% to about 50% by dry weight of the matrix protein content;
c) plant-based protein isolate contributing protein in an amount of about 40% to about 50% by weight of the matrix protein content;
d) casein-containing protein in an amount of about 6% to about 12% by dry weight of the matrix protein content;
e) hydrolyzed collagen contributing protein in an amount of about 1.5% to about 4% by dry weight of the matrix protein content;
f) soluble fiber syrup in an amount of about 28% to about 38% by weight of the matrix;
g) glycerol in an amount of about 5% to about 12% by weight of the matrix; and
h) non-glycerol sugar alcohol in an amount of about 4% to about 10% by weight of the matrix;
2) particulates in an amount of about 10% to about 20% by weight of the composition, the particulates distributed throughout the matrix, and contributing protein in an amount of about 15% to about 32% by dry weight of the product protein content;
b. a fat-based coating at least partially coating the composition, the fat-based coating comprising about 15% to about 22% by weight of the food product and contributing protein in an amount of about 5% to about 22% by dry weight of the product protein content.

2. The food product of claim 1, wherein the food product contains less than 20% by weight fat.

3. The food product of claim 1, wherein the matrix comprises less than 3% by weight hydrolyzed or partially hydrolyzed dairy protein and less than 3% by weight milk protein isolate and milk protein concentrate.

4. The food product of claim 1, wherein the plant-based protein isolate comprises soy protein isolate, pea protein isolate, or wheat protein isolate.

5. The food product of claim 4, wherein the plant-based protein isolate comprises soy protein isolate.

6. The food product of claim 1, wherein the matrix comprises lecithin in an amount of 0% to about 3% by weight of the matrix.

7. The food product of claim 1, wherein the particulates comprise soy crisps, soy nuggets, or soy puffs having a protein content of at least 80% by dry weight of the particulates.

8. The food product of claim 1, wherein the matrix comprises cocoa powder, vegetable powder, nut flour, legume flour, and/or fruit powder in an amount of up to 8% by weight of the matrix.

9. The food product of any of claim 1, wherein the plant-based protein isolate comprises at least a first soy protein isolate and a second soy protein isolate.

10. The food product of claim 1, wherein the composition comprises inclusions.

11. The food product of claim 1, wherein the matrix comprises:
a) a matrix protein content of 30% to about 45% by weight of the matrix;
b) whey protein isolate contributing protein in an amount of about 44% to about 50% by dry weight of the matrix protein content;
c) soy protein isolate contributing protein in an amount of about 40% to about 46% by dry weight of the matrix protein content;
d) casein-containing protein in an amount of about 7% to about 11% by dry weight of the matrix protein content;
e) hydrolyzed collagen contributing protein in an amount of about 1.8% to about 3% by dry weight of the matrix protein content;
f) liquid inulin or fructooligosaccharide syrup in an amount of about 30% to about 36% by weight of the matrix;
g) glycerol in an amount of about 6% to about 10% by weight of the matrix;
h) erythritol in an amount of 5% to about 9% by weight of the matrix; and
i) lecithin in an amount of about 1% to about 3% by weight of the matrix.

12. A method of making a shelf stable food product, the food product having a product protein content over 30% by weight, and a net carbohydrate content of less than 7% by weight, the method comprising:
a. providing a dry mix, the dry mix having a matrix protein content contributing protein in an amount of about 60% to about 75% by dry weight of the product protein content, including:
i. whey protein isolate contributing protein in an amount of about 40% to about 50% by dry weight of the matrix protein content;
ii. plant-based protein isolate contributing protein in an amount of about 40% to about 50% by dry weight of the matrix protein content;
iii. casein-containing protein in an amount of about 6% to about 12% by dry weight of the matrix protein content; and
iv. hydrolyzed collagen contributing protein in an amount of about 1.5% to about 4% by dry weight of the matrix protein content;
b. providing a slurry, including:
i. soluble fiber syrup in an amount of about 50% to about 65% by weight of the slurry;
ii. glycerol in an amount of about 10% to about 20% by weight of the slurry; and
iii. non-glycerol sugar alcohol in an amount of about 7% to about 16% by weight of the slurry;
c. combining the dry mix and the slurry and mixing until combined to form a matrix including the matrix protein content in an amount of least 30% by weight of the matrix;
d. combining the matrix with particulates to form a composition that includes the matrix in an amount about 80% to about 90% by weight of the composition and the particulates in an amount of about 10% to about 20% by weight of the composition, the particulates distributed throughout the matrix and contributing protein in an amount of about 15% to about 32% by dry weight of the product protein content;
e. cold-forming the composition to produce core pieces; and
f. at least partially coating the core pieces with a fat-based coating to make the food product, the fat-based coating comprising about 15% to about 30% by weight of the food product and contributing protein in an amount of about 5% to about 25% by dry weight of the product protein content.

13. The method of claim 12, wherein the non-glycerol sugar alcohol comprises erythritol in an amount of about 8% to about 15% by weight of the slurry.

14. The method of claim 13, comprising a step of heating the slurry to at least partially dissolve the erythritol.

15. The method of claim 14, comprising a step of cooling the slurry prior to combining with the dry mix.

16. The method of claim 12, wherein the plant-based protein isolate comprises soy protein isolate, pea protein isolate, or wheat protein isolate.

17. The method of claim 16, wherein the plant-based protein isolate comprises soy protein isolate.
